(19) United States
(12) Patent Application Publication
(10) Pub. No.: US 2024/0420593 A1
(43) Pub. Date: Dec. 19, 2024

(54) SURGICAL TRAINING MODEL AND ASSOCIATED INFRARED LIGHT BASED IMAGING SYSTEM

(71) Applicant: ENCORIS GROUP CORPORATION, Holland, MI (US)

(72) Inventors: Jim TenBrink, Holland, MI (US); Harley Domasik, West Olive, MI (US); Joel Zylstra, Hudsonville, MI (US); Warren Edwin Guthrie, West Olive, MI (US); Timothy Cullen Davison, Coloma, MI (US)

(73) Assignee: ENCORIS GROUP CORPORATION, Holland, MI (US)

(21) Appl. No.: 18/747,391

(22) Filed: Jun. 18, 2024

Related U.S. Application Data
(60) Provisional application No. 63/521,859, filed on Jun. 19, 2023.

(51) Int. Cl. G09B 23/28; G09B 23/30

(52) U.S. Cl. CPC G09B 23/286; G09B 23/30

(57) ABSTRACT

A surgical training system includes a surgical training model formed from materials that resemble bone and body tissue. The surgical training model is opaque to visible light and is partially transmissive to IR light. A complementary surgical imaging system includes an IR emitter which emits IR light across a region of interest in the surgical training model and an IR receiver which receives light which is emitted from the IR emitter and which passes through the surgical model. The system produces images which resemble medical X-ray images. The system allows for surgical training and is particular suited for procedures such as arthroscopic procedures which are reliant on medical imaging.

### PRIORITY

The present application claims the benefit of U.S. Provisional Application Ser. No. 63/521,859, filed Jun. 19, 2023, which is herein incorporated by reference in its entirety.

### THE FIELD OF THE INVENTION

The present invention relates to surgical training. In particular, examples of the present invention relate to a surgical training model and IR imaging system for use in surgical training to visualize the training instruments and the surgical procedure performed within the anatomical surgical training model.

### INTRODUCTION

Surgical procedures require a large amount of practice before they are performed on a live patient to maximize the likelihood of a successful surgical outcome. Surgical training has typically been performed on a cadaver and has utilized X-ray imaging to facilitate and validate the procedure. Minimally invasive surgical procedures such as arthroscopic, vasculature, orthopedic, and pain management surgeries are particularly reliant on X-ray imaging as many aspects of the procedure are not visually apparent from the outside of the cadaver. Use of X-ray imaging to visualize a surgical procedure while training is disadvantageous as it exposes the surgical staff to harmful radiation. The use of a cadaver for the surgical procedure is expensive. The present invention solves many of the deficiencies in traditional surgical training by providing an anatomically correct surgical training model and by providing a training model and an imaging system that eliminates the need for X-ray imaging during the training procedure. The surgical training model is formed from varied materials to create structures which realistically replicate desired anatomical structures. These structures are created with varying opacity or transmissivity to IR light. The training model replicates a desired anatomical structure for a surgical procedure and provides a model which realistically replicates tissue and structures for the surgeon. An IR emission and imaging system is provided which works in combination with the surgical model and provides imaging capabilities that simulate X-ray images without exposure to harmful radiation. The surgical training system reduces the cost of the training procedure.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a schematic drawing which shows a surgical training system including a surgical training model and a surgical imaging system.

FIG. 2 is a drawing of components of the IR emitter of FIG. 1.

FIG. 3 is a schematic drawing of components of the IR receiver of FIG. 1.

FIG. 4 is a schematic drawing of the computer system of FIG. 1.

FIG. 5A is a drawing of a non-linear brightness transform function.

FIG. 5B is a drawing of a non-linear brightness transform function.

FIG. 5C is a drawing of a non-linear brightness transform function.

FIG. 6 is a drawing of an alternate embodiment of the imaging system frame of FIG. 1.

FIG. 7 is a drawing of an alternate construction of the IR emitter.

FIG. 8 is an example medical image produced by the surgical training system of FIG. 1.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Embodiments may also be implemented in cloud computing environments. In the description and claims, “cloud computing” may be defined as a system for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud system can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). The flowchart or process steps may be performed in alternate order so long as the change in order does not materially alter the result. Each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used herein, “adjacent” refers to near or close sufficient to achieve a desired effect. Although direct contact is common, adjacent can broadly allow for spaced apart features.

As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be one or two significant digits above or one or two significant digits below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range.

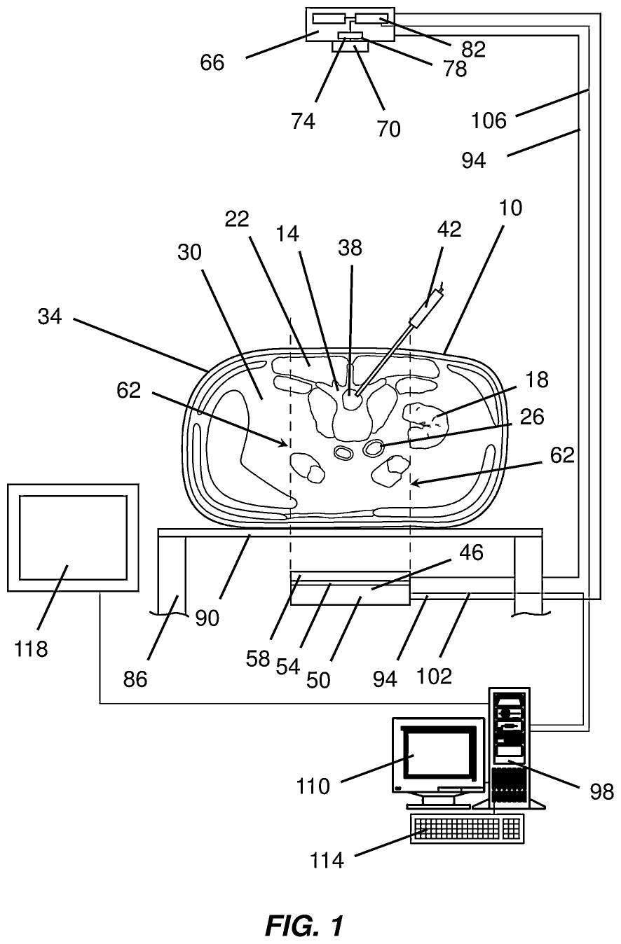

Turning now to FIG. 1, the surgical training system includes a surgical training model 10. As used herein, the term model refers to a physical model that simulates body tissue and structures and may include bone, organs, muscle, skin, and other tissue. The surgical training model is used for surgical training and is cut, sutured, or otherwise modified in accordance with a desired surgical procedure. The surgical training model 10 is constructed to include various anatomical features as are desired for the training procedure. By way of example, the surgical training model 10 includes anatomical features such as bones 14 (e.g., vertebra 14), organs 18, muscles 22, blood vessels 26, fat tissues or generalized tissue 30, skin 34, and nerve tissue 38. The anatomical features present in the surgical training model 10 are selected for a desired surgical procedure. An entire body is often not provided and the surgical training model 10 typically includes a portion of a human body with the major anatomical features present in this location of the body. Anatomical features which are interacted with during the surgical procedure as well as surrounding or associated features and anatomical features which commonly present an obstacle during the procedure are typically provided in the surgical training model 10 so as to present a realistic training scenario for the surgeon. A surgeon will typically interact with the surgical training model 10 with one or more surgical instruments 42. Surgical instruments 42 often include a scalpel, arthroscopic instruments, suturing instruments, etc.

The surgical training model 10 is created to interact with infrared (IR) light for simulated medical imaging. Accordingly, the various anatomical structures present in the surgical training model 10 are constructed with materials with varying opacity or transmissivity to IR light. In one example, the anatomical structures are formed from urethane (e.g. polyurethane) or silicone elastomer and include different additives to modify the color, physical properties, and IR transmission properties of the anatomical structure. Additives such as Nigrosin or Epolin E2057 may be used to alter the IR opacity of the materials used to create the tissues. Dyes may be mixed with a suitable solvent to dissolve the dye, the dissolved dye mixed with the elastomer or other material used to create an anatomical structure, the solvent extracted from the elastomer material such as by vacuum evaporation, and the material cured to create the biological tissue.

For example, fat tissue or undifferentiated tissue 30 may be constructed from silicone with a hardness of about Shore A 0 through about Shore A 20, may be dyed or colored to present a cream or yellow visual color, and may include an additive to mildly absorb IR light. Skin tissue 34 may be constructed from silicone with a hardness of about Shore A 10 through about Shore A 30, may be dyed or colored to present a beige visual color, and may include an additive to mildly absorb IR light to a greater degree than the fat tissue. Muscle tissue 22 may be constructed from silicone with a hardness of about Shore A 20 through about Shore A 40, may be dyed or colored to present a red or reddish beige color, and may include an additive to moderately absorb IR light. Bone 14 may be constructed from silicone polymer with a hardness of about Shore A 70 through about Shore A 100 or about Shore D 90, may be dyed or colored to present a white or ivory visual color, and may include an additive to moderately absorb IR light to a greater degree than that of muscle tissue.

In one example, bone tissue 14 may be formed from a different material than surrounding tissues. Bone tissue 14 may be formed from a urethane material. Bone tissue 14 may also be created to have a rough outer surface by mechanically abrading the molded bone component or by creating a bone mold with roughened mold walls such that the molded part has a roughened exterior. The overall surgical training model 10 may be created by forming individual anatomical structures, positioning these within a larger mold, and then overmolding the anatomical structures with an overlaying or surrounding anatomical structure such as fat 30, undifferentiated tissue 30, or skin 34. The example formulations of the various anatomical structures present in the surgical training model 10 provide a model which more accurately resembles real anatomy in visual and physical characteristics. The example anatomical structures are recreated so that they are visibly opaque or nearly opaque and selectively absorb a fraction of IR light to thereby allow the surgical training model 10 to be imaged with the disclosed IR imaging system with results that simulate X-ray imaging.

The surgical training model 10 includes a first tissue (such as bone, tendon, blood vessels, organs, etc.) with a first transmissivity to IR light and a second tissue (such as skin, fat, muscle, blood vessels, organs, etc.) with a second transmissivity to IR light. When the surgical training model 10 is imaged with the IR imaging system, the different IR transmissivity of the different tissues within the training model 10 cause these to transmit IR light differently and to thereby be visually differentiated as different structures in the resulting medical image created by the imaging system. Multiple different types of tissues with different visual, mechanical, and IR transmissivity properties may be used in the training model 10 to create a realistic surgical experience related to the depicted anatomical structures.

The IR imaging system includes a planar IR emitter 46. The IR emitter 46 emits generally colinear IR light over an area which is approximately equal to or larger than the desired anatomical area which is being imaged. In many surgical training scenarios, the anatomical area being imaged is about 10 cm by about 15 cm and the IR emitter is about 10 cm by about 15 cm or larger. Generally, the IR emitter emits IR light across an area that is greater than about 5 cm by 5 cm, and more preferably an area that is about 10 cm by about 15 cm or larger. The construction of the IR emitter 46 is such that the IR emitter 46 may be enlarged to provide larger imaging capabilities without excessively increasing the overall system cost and operating cost. The IR emitter 46 includes an IR emission array 50. The example IR emitter array 50 is an array of narrow beam IR diodes with a viewing angle of about 10 degrees that are attached together in an array with a size that matches the desired imaging area. The IR emitter 46 includes a diffuser 54 that is attached in front of the IR emitter array 50 and which evens out the light from the IR emitters to eliminate hot spots in the IR light output. The IR emitter 46 may also include an anti-scatter grid 58 which is placed optically downstream from the diffuser 54. The anti-scatter grid 58 typically includes a large number of parallel, small size, and elongate pores separated by septum walls. The pores are aligned with the desired direction of IR light travel and the walls between the pores absorb light that is greater than a certain angle off axis of the desired direction of light travel. In the example IR emitter 46, the pores are parallel and the anti-scatter grid 58 absorbs IR light that deviates from perpendicular to the IR emitter 46 by more than a desired angle. Longer and/or narrower pores through the anti-scatter grid 58 will produce a light emission that is closer to colinear while absorbing more of the light output from the emission array 50. Shorter and/or wider pores through the anti-scatter grid 58 will allow more light to pass through and will produce light that is somewhat less colinear. The IR emitter 46 may also include power and control hardware necessary for operation of the IR emitter 46.

The IR emitter 46 emits generally parallel IR light across a broad area which is greater than or equal to the desired sensing area of the surgical training model 10. In the example system, IR light is emitted through the surgical training model 10 across the area designated by dashed lines 62. IR light which passes through the surgical training model 10 is captured by an IR imaging receiver 66. The imaging receiver 66 includes a lens 70 that focuses light from the imaging area, an IR bandpass filter 74 that allows IR light to pass into the receiver and absorbs or reflects other frequencies of light, and an IR sensor 78 such as a CMOS sensor capable of detecting IR light. The IR imaging receiver 66 typically includes control hardware 82 which operates the receiver 66 and processes and transmits data from the sensor 78.

The IR emitter 46 is placed below the surgical training model 10 and is typically placed relatively close to the surgical training model 10. The IR receiver 66 is placed above the surgical training model 10 and is aligned with the IR emitter such that a central axis extending through the lens 70 of the IR receiver 66 is aligned with a central axis extending perpendicular to the center of the IR emitter 46. The IR receiver 66 is spaced farther apart from the surgical training model 10 and is typically about 1 meter away from the surgical training model. In the example system, the surgical training model 10 is supported on a table 86 that includes an upper support surface 90 which is transparent to IR light, such as a surface made from a sheet of PMMA (acrylic). The IR emitter 46 is positioned beneath the table 86. The IR emitter 46 is attached to a frame 94 that supports and positions the IR emitter 46. The frame is also connected to the IR receiver 66 to position the receiver a desired distance away from the surgical training model 10 and to align the IR receiver 66 with the IR emitter 46. The frame 94 allows the IR emitter 46 and IR receiver 66 to be moved in tandem to position them at a desired location relative to the surgical training model 10. The IR receiver 66 may include an alignment guide such as a low powered laser than can be selectively activated to project visual light onto the surgical training model 10 and to thereby indicate on the surgical training model 10 the center of the area which will be imaged by the imaging system.

The IR emitter 46 is connected to a power source and a control computer 98 by communication wires 102. The IR emitter 46 may be powered by a separate power supply or alternatively the computer 98 may provide power to the IR emitter 46 and also control operation of the IR emitter 46. The IR emitter 46 may be operated by the computer 98 during a desired period of time to create an image of the surgical training model 10. The IR receiver 66 is also connected to the computer 98 by communication wires 106. The computer 98 controls operation of the IR receiver 66 via the communication wires 106 and receives image data from the IR receiver 66 via communications wires 106. In some example configurations, the IR receiver 66 may include sufficient onboard power, control circuits, and memory to operate in a standalone manner and images can be transferred to the computer 98 via a wireless network or the like.

The computer 98 includes a user interface which may include a display such as screen 110 and a user input device such as a touch screen 110 or a mouse/keyboard 114. The user interface allows a user to operate software on the computer 98 and control operation of the IR emitter 46 and IR receiver 66. The computer 98 displays medical images of the surgical training model 10 on a display 118 which may be separate from the computer display 110 or which may be the same device as display 110.

In normal use of the surgical training system, the user (often a doctor or surgeon) places the imaging system in a desired configuration to facilitate creation of a medical image of the surgical training model 10 at a desired location/section of the surgical training model 10. The medical image may be preoperative to diagnose a medical issue, during operation to verify positioning of surgical tools 42 or to validate surgical techniques, or after the operation to validate the surgical procedure. The user will place the surgical training model 10, surgical tools 42, and IR emitter 46 and IR receiver 66 in a desired configuration. The user or an assistant then operates the computer 98 and thereby the IR emitter 46 and IR receiver 66 to cause the IR emitter 46 to project generally parallel IR light through the surgical training model 10 and to cause the IR receiver 66 to capture an image of IR light which passes through the surgical training model. The surgical training model 10 absorbs IR light as the IR light passes through the surgical training model with portions of the surgical training model that represent more dense tissue such as bone absorbing more light and other tissue absorbing less light. Image data is then transmitted from the IR receiver 66 to the computer 98. The computer 98 edits the image to alter the image and displays the edited image on the display 118 (or 110) for the user to review. The image is also stored on the computer 98.

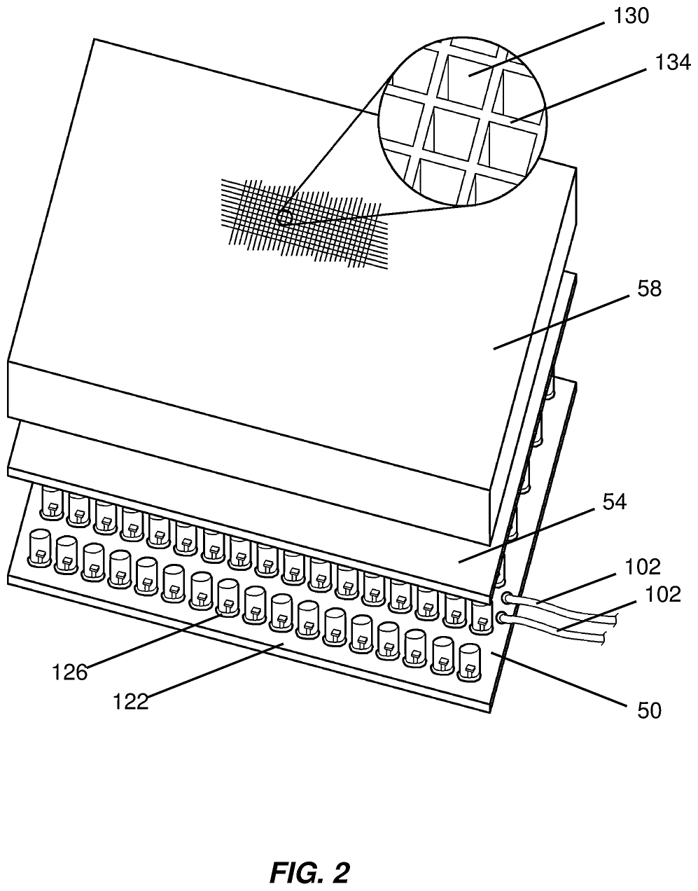

FIG. 2 shows a detailed view of the components of the IR emitter 46. The example IR emission array 50 includes a circuit board 122 which is populated with an array of narrow viewing angle IR diode emitters 126. Performance of the imaging system is improved with better collimated light. Accordingly, narrow beam angle LED diodes are preferable. Diodes with less than about 15 degree viewing angles are preferred, and diodes with a viewing angle which is about 8 degrees or about 10 degrees are preferred. A sufficient number of diodes are provided in the array to cover a desired imaging area of the surgical training model 10, to provide some overlap in the diode output beams and create a more even output pattern, and to provide a desired a desired output power per unit area. The diodes are connected in series/parallel combinations to a power inlet connector and receive power from a power supply via control wires 102. The diffuser 54 is typically a relatively thin sheet placed optically downstream from the IR emitters 126 and helps to even out the light from the emitters 126. The anti-scatter grid 58 includes a plurality of pores 130 which are separated by septum (walls) 134. The septum 134 form walls which isolate pores 130 from adjacent pores 130. The pores 130 have a length and a width which causes light to pass through the anti-scatter grid 58 if it is perpendicular to or within a predetermined angle from perpendicular to the anti-scatter grid 58 (i.e. a predetermined angle from parallel to the center line of the axis of the pore 130). IR light which is more than a predetermined angle from perpendicular to the grid (parallel to the pore axis) will hit the walls 134 and is absorbed by the walls 134. Typically, the pores 130 are relatively small in diameter or cross-section to better collimate the IR light and the walls 134 are thin so that a high amount of light passes through the anti-scatter grid 58. The pores 130 typically have a width which is between about 5 percent and about 15 percent of the length of the pore. The anti-scatter grid 58 will typically improve the quality of images produced by the IR imaging system.

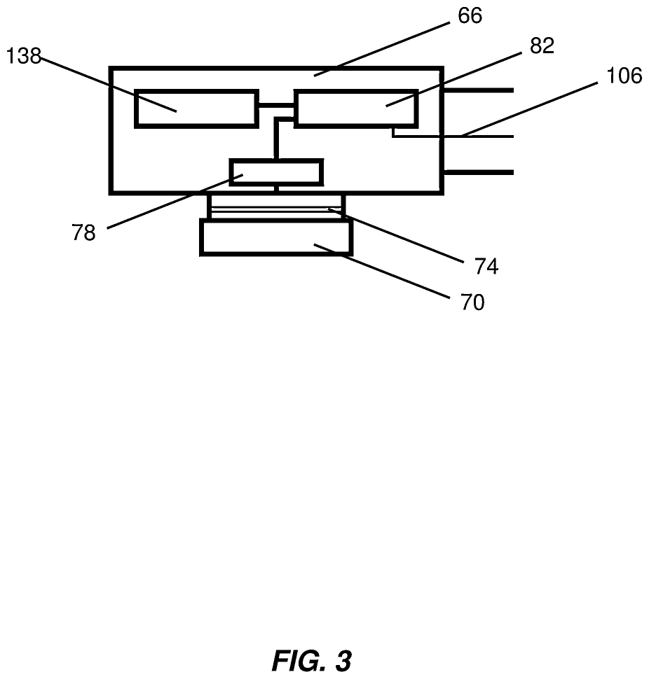

FIG. 3 shows a schematic drawing of the IR receiver 66. The IR receiver 66 uses an IR sensitive sensor 78 such as a CMOS sensor to capture IR light which passes through the surgical training model 10 and thereby creates an image of the training module. A lens 70 and an IR bandpass filter 74 appropriate to the emission spectrum of the IR emitters 126 are used to restrict the light that reaches the sensor 78 to the wavelength emitted by the IR emitter 46 and to focus the light on the sensor 78. The IR receiver 66 may implement a mechanical iris or shutter to control image exposure or may utilize a digital iris to control image exposure. The IR receiver 66 may have an internal power source or may receive power from an external source such as the computer 98. Control hardware 82 typically includes a microprocessor control circuit 82 which controls operation of the sensor 78 and which also receives image data from the sensor and transmits and processes the image data from the sensor. The control circuit 82 may communicate with camera memory 138 which may be onboard the control circuit, processing chip, or separate memory. The memory 138 may store image data received from the sensor 78 and also store processed image data which forms a complete image. Images are typically transmitted to the computer 98 via communications cable 106.

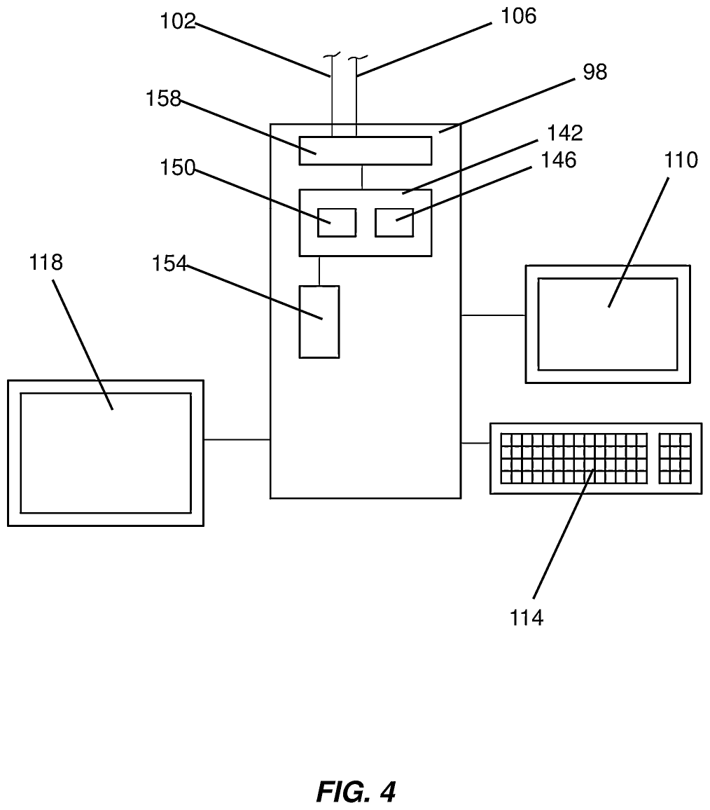

FIG. 4 shows a schematic diagram of the electronic components used in the computer 98. The computer 98 typically includes a processing device 142 which can include memory, e.g., read only memory (ROM) and random access memory (RAM), storing processor-executable instructions and one or more processors that execute the processor-executable instructions. The processing device 142 can execute the software/firmware used to operate the IR emitter 46 and the IR receiver 66, and to receive image data from the IR receiver 66. In one example, the processing device 142 executes an imaging system control module 146 and a medical image processing module 150. The computer 98 may also include memory 154 such as a hard disk drive and/or solid state memory. The memory 154 may store the medical imaging software used to execute the imaging control module 146 and the medical image processing module 150 and operate the IR emitter 46 and the IR receiver 66. The memory 154 may also store digital medical images produced by the IR imaging system. The computer 98 may also include an interface device 158 which performs communications and data interface functions. The interface device 158 may send and receive power and data signals to and from the IR emitter 46 and the IR receiver 66. The interface device 158 may include a power signal input/output which sends electricity to the IR emitter 46 to operate the IR emitter 46 and, if desired, to sense the operational state of the IR emitter 46. The interface device 158 may include a data interface which receives surgical model image data from the IR receiver 66 control circuit 82. The computer 98 also sends and receives data to/from a user interface 110, 114, 118.

The user interface 110, 114 allows a user to interact with the computer 98 and the IR imaging system. The term “user interface” can include, but is not limited to, a screen 118, a touch screen 110, a physical keyboard 114, a mouse, etc. The user interface may receive inputs from the user to select operational parameters for the medical imaging system and may display operational parameters to the user. The user interface may allow the user to select operational parameters for the operation of the IR emitter 46 and IR receiver 66 as well as imaging post-processing settings. In particular, the user interface may allow the user to select surgical model image exposure settings, operate the IR imaging system, initiate the capture of surgical model images, and view the surgical model medical images.

Settings may be selected for the medical imaging system to provide desired qualities in the produced surgical model image. The intensity or duration of the IR emitter 46 may be controlled along with gain and exposure timing settings in the image sensor 66 to capture a desired amount of IR light transmitted through the surgical training model 10 and thereby create a surgical model image that has a desired balance between light and dark areas and that adequately demonstrates differences between air, materials in the surgical training model 10 simulating fat tissue 30, muscle tissue 22, skin tissue 34, bone 14, and metal such as in surgical instruments 42.

The imaging system control module 146 may store settings related to intensity and duration of the IR emitter 46, gain and shutter duration of the IR receiver 66, and associated settings. The imaging system control module 146 may provide signals to the IR emitter 46 to operate the IR emitter 46 at a desired intensity and for a desired duration and provide signals to the IR receiver 66 to operate the IR receiver 66 at a desired gain setting and for a desired duration to thereby capture a surgical model image of the training model 10. Operation of the IR emitter 46 causes largely colinear light to be emitted from the emitter 46 and to pass through the surgical training model 10. IR light is selectively absorbed by the materials forming the surgical training models, as these materials are manufactured to have desired IR absorption and IR transmission properties with materials representing bone having a lower IR transmission than materials representing softer tissues. IR light passes out of the surgical training model 10 with the intensity of transmitted light varying according to the type of material and the thickness of material that the IR light passed through in the surgical training model. The IR light that is transmitted through the surgical training model is captured by the IR receiver 66. The surgical model medical image is captured as a black and white image by the image sensor 78. Accordingly, the imaging system control module 146 may:
Receive an image exposure setting from a user
Determine IR emitter intensity and duration settings
Determine IR receiver gain and exposure duration settings
Output a signal to the IR emitter to cause operation of the IR emitter at a desired intensity and for a desired period of time to cause IR light to pass through the surgical training model
Output a signal to the IR receiver to cause operation of the IR receiver capture a surgical model image of the surgical training model 10
Receive surgical model medical images as data from the IR receiver 66
Process surgical model medical images
Store surgical model images as data in computer memory 154
Display surgical model images on a display 118 or 110

The medical image processing module 150 may be operated by the computer to alter the surgical model images and create medical images which are presented to the user. In many cases, the raw surgical model medical images directly created by an IR receiver 66 are not desirable for display to a user. The surgical model images depict the transmission of IR light through the surgical model materials. A material 14 simulating bone blocks more IR light and is depicted as darker by the IR receiver 66 compared to air which transmits more IR light. The resulting image is not natural to a user and air is more easily understood as black in a medical image representing a lack of structure. Similarly, bones are more easily understood as light objects in a medical image representing a structure. Accordingly, the medical image processing module 150 may take the surgical model images received from the IR receiver 66 and process these images to invert the black and white color values in the surgical model images; causing the materials that absorb or block more IR such as instruments or bones to appear white or lighter and causing materials that transmit more IR light such as air or tissues to appear darker or black. The medical image processing module 150 may also edit the surgical model images by applying histogram equalization to the image to better spread the dark and light values present in the image across the observable dark and light values and thereby provide better contrast across the displayed image. The processing module may apply a histogram function to the surgical model medical image data, analyze the histogram data to determine areas along the histogram with underpopulated pixel intensities and areas with overpopulated pixel intensities, and adjust the image data to spread out the areas of overpopulated pixel intensities along a greater range of intensity (black and white color values) to better spread out the image color values and improve the image contrast.

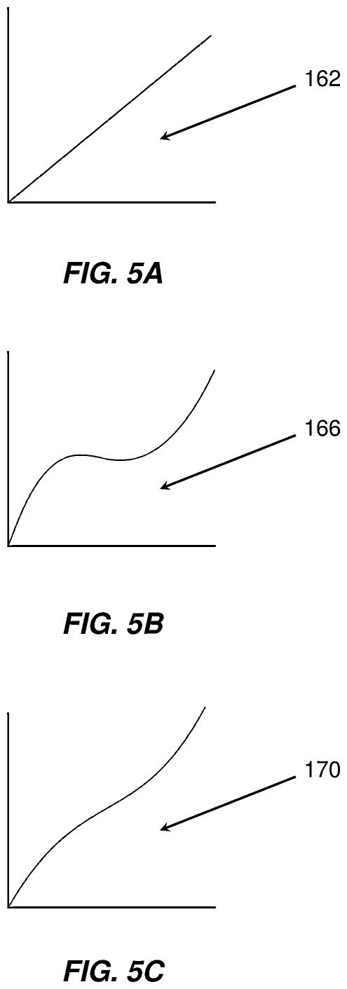

The medical image processing module may also edit the surgical model images by applying a non-linear brightness transform function to the images. FIGS. 5A through 5C show example image brightness/intensity transform functions. 162 indicates an initial linear relationship between recorded and displayed image brightness. A transform function 166 which lowers brightness at low values and raises displayed brightness at high values is indicated at 166. The resulting relationship between displayed brightness (y axis) versus recorded brightness (x axis) is indicated at 170. Application of a predefined transform function to the image brightness may be used to edit the image brightness in a predetermined manner to better highlight differences in the medical training model simulated tissue; particularly the difference between simulated bone and simulated soft tissue.

The medical image processing module 150 may also edit the surgical model images to intentionally blur the images. The disclosed IR medical imaging system is capable of capturing images of medical training models that are clearer than conventional X-ray images. These images are thus not totally representative of what a surgeon would encounter in an actual surgical procedure on a patient when using X-ray imaging during the procedure. The medical imaging processing module 150 may use a blurring function such as a gaussian blur to lower the detail and sharpness in the image to better represent an actual surgical procedure in the training environment. For the example system, the blur often uses between about 50 and about 100 surrounding pixels to blur the target pixel. Additionally, the system can be used to better facilitate training of surgeons. In one example, sharper images may be presented to a user who is new at performing a procedure. As the person has performed more procedures, the images may be increasingly blurred until they are similar to images produced by X-ray imaging systems. This will allow the user to learn the procedure more quickly as they can better see the surgical techniques being performed within the surgical training model while they are inexperienced and the difficulty in observing the image is increased as the user skill increases. Such a surgical training model 10 is often used with procedures such as arthroscopic, vasculature, orthopedic, or pain management procedures where the surgeon cannot directly see the structures being operated on and is reliant on medical imaging.

The medical image processing module 150 may:
Receive a surgical model image from the IR receiver 66 or from the computer 98
Alter the surgical model image by inverting the image brightness
Alter the surgical model image by applying a histogram equalization function
Alter the surgical model image by applying a non-linear brightness transform function to the surgical model image
Alter the surgical model image by blurring the surgical model image
Creating a medical image from the modified surgical model image
Store the medical images as data in computer memory 154
Display medical images on a display 118 or 110

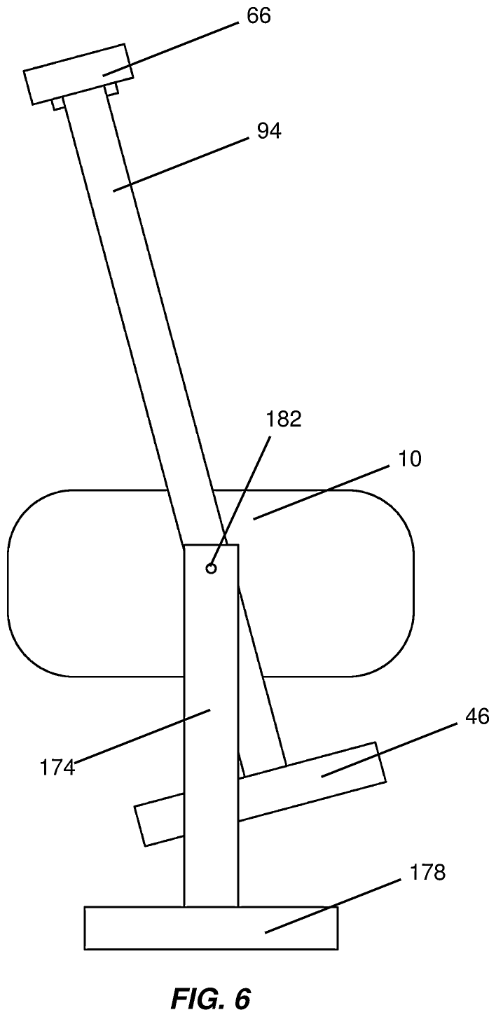

FIG. 6 shows a drawing of a rotatable imaging frame 94 which allows the IR emitter 46 and the IR receiver 66 to be rotated to vary the image taken of the surgical training model 10. The frame 94 which supports the IR emitter 46 and IR receiver 66 is attached to a support frame 174 and stand 178 via pivot 182. This allows the frame 94 to be pivoted about pivot 182 to capture images through the surgical training model 10 at different angles. Similar to the frame shown in FIG. 1, the frame 174 and stand 178 may be moved laterally and forwards and backwards in addition to rotation of the frame 94 to vary the portion of the surgical training model 10 that is imaged. Many of the structures shown in FIG. 1 such as the table 86 and support surface 90 are not shown in FIG. 6 for clarity in showing the pivotable frame. FIG. 6 shows a lateral view taken from the right side of FIG. 1.

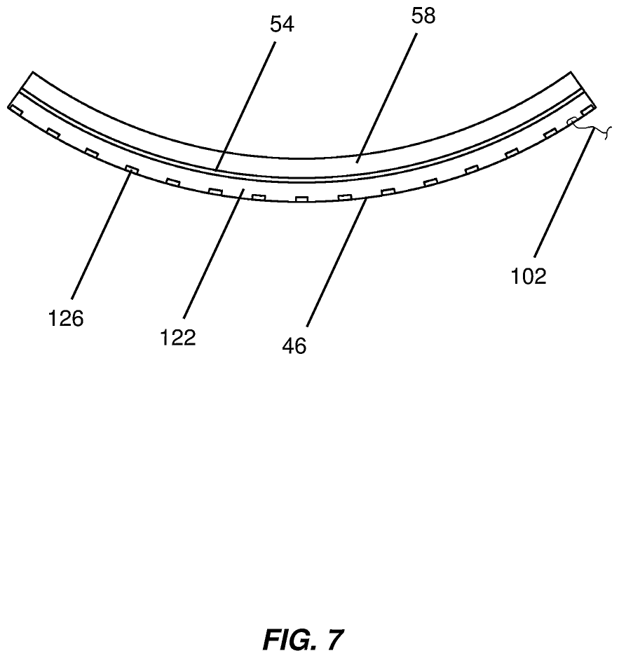

FIG. 7 shows an alternate design for the IR emitter 46 where the IR emitter 46 is larger in size than the area imaged by the IR receiver 66 and/or where the IR emitter 46 is curved. As described above, the IR emitter 46 includes a larger circuit board 122 and an array of IR diodes 126, a larger diffuser 54, and a larger anti-scatter grid 58. This allows the IR receiver 66 to be moved about independent of the IR emitter 46 to capture images of the surgical training model 10 while simplifying the frame design and simplifying alignment of the IR receiver 66 with the IR emitter 46. A curved design for the IR emitter 46 allows the IR emitter 46 to function with a pivoting frame 174 as shown in FIG. 6 while only requiring the IR receiver 66 and an associated upper frame 94 to move and pivot. A curved IR emitter 46 may include an anti-scatter grid 58 which is curved. Such a grid includes pores 130 and walls 134 as described above but which are aligned with a line which is perpendicular to the surface of the anti-scatter grid 58 at the location of the pore 130 or wall 134. The pores 130 and walls 134 are not all parallel to each other but change angle according to the curvature of the anti-scatter grid 58.

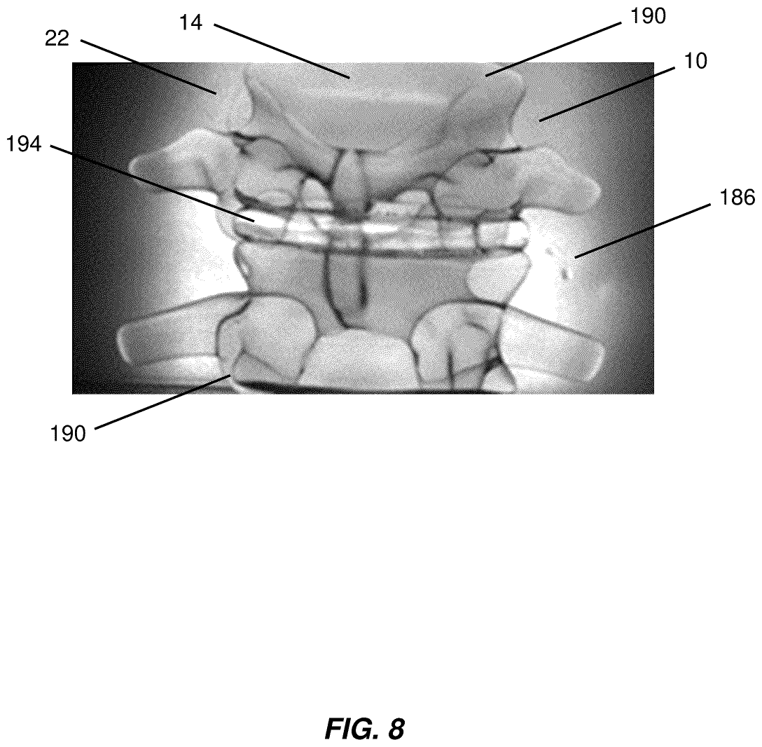

FIG. 8 shows an example medical image 186 produced with a surgical training model 10 and the IR based medical imaging system disclosed herein. The portion of the surgical training model 10 shown in the image includes two simulated bones 14 which are vertebrae 190, simulated surrounded muscle tissue 22, and a simulated soft material artificial disc or disc spacer 194 as may be used in a surgery to treat a degenerated spinal disc. The medical image 186 has been produced by illuminating the surgical training model 10 with and IR emitter 46, allowing IR light to pass through the surgical training model 10, and capturing the transmitted IR light with an IR receiver 66 as discussed herein. The surgical model image captured by the IR receiver 66 has been edited as discussed to produce the resulting medical image 186. The medical image 186 displays distinct periphery and edges for the simulated vertebral bones 14, 190 and distinct edges for and between simulated structures such as the disc 194 and surrounding muscle tissue 22. The medical image 186 provides a realistic medical image that is valuable in training medical professionals to perform surgeries.

The surgical training model 10 and complementary medical imaging system are advantageous in many ways. The system avoids the high cost and limited availability of cadavers for performing training procedures. The system provides medical images 186 which are comparable to conventional X-ray images without exposing the system users to harmful radiation and without the higher cost of an X-ray imaging system. The training system provides a realistic surgical training experience to the users. The quality of the produced medical images 186 can be adjusted to reflect variation in medical images that may be experienced during surgeries. The quality of the produced medical images 186 can also be adjusted to provide a high degree of sharpness not typically available with X-ray imaging to accelerate a learning process and then be adjusted to provide lower quality medical images 186 to better simulate an operating room experience.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, voltages, currents, frequencies, power range values, times, etc., are provided for explanation purposes and that other values may also be employed in other examples in accordance with the teachings of the present invention.

What is claimed is:

1. A surgical training and imaging system comprising:
a surgical training model which represents part of a human body, the surgical training model comprising:
a first simulated tissue having a first light transmissivity for IR light;
a second simulated tissue which is different than the first simulated tissue and which represents a different anatomical structure than the first simulated tissue, the second simulated tissue having a second light transmissivity for IR light that is different than the first light transmissivity, wherein the second simulated tissue is disposed inside of the first simulated tissue;
a surgical imaging system comprising:
an IR emitter, wherein the IR emitter is selectively operated to emit IR light such that the IR light passes through a section of the surgical training model;
an IR receiver, wherein the IR receiver comprises an imaging sensor which is sensitive to IR light and which receives IR light that passes through the section of the surgical training model and creates image data from the IR light;
a computer system programmed to:
electronically receive image data from the IR receiver;
process the image data to thereby create a medical image from the image data, wherein the medical image shows the second simulated tissue within the first simulated tissue; and
display the medial image on a computer display.

2. The system of claim 1, wherein the IR emitter is disposed on a first side of the surgical training model and wherein the IR receiver is disposed on a second side of the surgical training model opposite the first side.

3. The system of claim 1, wherein the IR emitter is positioned beneath the surgical training model and emits IR light upwardly through the surgical training model, and wherein the IR receiver is positioned above the surgical training model by a distance greater than 0.5 meters and is aimed at the surgical training model to receive IR light that passes through the surgical training model from the IR emitter.

4. The system of claim 1, further comprising a support surface which supports the surgical training model during use, and wherein the support surface transmits IR light therethrough, and wherein one of the IR emitter and IR receiver is disposed below the support surface and below the surgical training model, and wherein the other of the IR emitter and IR receiver is disposed above the surgical training model.

5. The system of claim 1, wherein the second simulated tissue comprises a simulated bone having a second hardness which is higher than a first hardness of the first tissue and a second IR transmissivity that is lower than the first IR transmissivity, and wherein the simulated bone absorbs a greater amount of the IR light than the simulated tissue and wherein the medical image displays the simulated bone within the simulated tissue.

6. The system of claim 5, wherein the simulated bone is constructed from a high durometer urethane and an IR absorbing material, wherein the simulated bone is visually colored to resemble bone and to be visually opaque, wherein the simulated bone comprises a roughened exterior surface, and wherein the simulated bone is partially opaque to IR light such that IR light is partially transmitted through the simulated bone.

7. The system of claim 5, wherein the first simulated tissue is constructed from silicone having a durometer hardness which is less than the hardness of the simulated bone and an IR absorbing material.

8. The system of claim 6, wherein the first simulated tissue is visually colored to resemble natural body tissue and to be visually opaque to thereby obscure visibility of the simulated bone through the simulated tissue.

9. The system of claim 1, wherein the IR emitter comprises:
an IR emission array that emits IR light across an area that is at least about 5 cm by about 5 cm.

10. The system of claim 9, wherein the IR emission array comprises an array of IR diodes having a size which is equal to or greater than a target area of the surgical training model which is to be imaged;
and wherein the IR emitter further comprises:
a diffuser placed optically downstream from the array of IR diodes;
an anti-scatter grid placed optically downstream from the diffuser;
wherein the anti-scatter grid comprises a grid having pores extending therethrough in a direction which is aligned along a line between the IR emitter and an IR receiver, wherein the pores are separated by walls, and wherein the pores have a cross sectional size and a length such that light passing through the anti-scatter grid is within a target deviation angle from a line between the IR emitter and the IR receiver and such that light from the IR emitter that is emitted at an angle greater than the target deviation angle from the line between the IR emitter and the IR receiver is absorbed by the anti-scatter grid.

11. The system of claim 1, wherein the IR receiver comprises:
a focusing lens; and
an IR bandpass filter.

12. The system of claim 11, wherein the system further comprises an alignment guide that directs visual light towards the upper surface of the training model to facilitate alignment of the IR receiver to facilitate imaging of a target area of the training model by the IR emitter and the IR receiver.

13. The system of claim 1, wherein the computer system is programmed to process the surgical training model image data by inverting the brightness of the surgical training model image.

14. The system of claim 1, wherein the computer system is programmed to process the surgical training model image data by at least one of:
applying a histogram equalization to the surgical model image; and
applying a non-linear correction curve to modify the brightness of the surgical training model image.

15. The system of claim 1, wherein the computer system is programmed to process the surgical training model image data by blurring the surgical training model image.

16. A surgical training and imaging system comprising:
a surgical training model which represents part of a body, the surgical training model comprising:
a first simulated tissue having a first IR light transmissivity;
a second simulated tissue which is different than the first simulated tissue and which represents a different anatomical structure than the first simulated tissue, the second simulated tissue having a second IR light transmissivity that is different than the first light transmissivity such that the second simulated tissue transmits a different amount of IR light than the first simulated tissue, wherein the second simulated tissue is disposed inside of the first simulated tissue;
a surgical imaging system comprising:
an IR emitter comprising an IR emission array that emits IR light across an area that is at least about 5 cm by about 5 cm, wherein the IR emitter is selectively operated to emit IR light such that the IR light passes through a section of the surgical training model;
an IR receiver, wherein the IR receiver comprises an imaging sensor which is sensitive to IR light and which receives IR light that passes through the section of the surgical training model and creates image data from the IR light;
a computer system programmed to:
electronically receive image data from the IR receiver;
process the image data to thereby create a medical image from the image data, wherein the medical image shows the second simulated tissue within the first simulated tissue; and
display the medial image on a computer display.

17. The system of claim 16, wherein the second simulated tissue comprises a second hardness which is different than a first hardness of the first tissue.

18. The system of claim 16, further comprising a support surface which supports the surgical training model during use, and wherein the support surface transmits IR light therethrough, and wherein one of the IR emitter and IR receiver is disposed below the support surface and below the surgical training model, and wherein the other of the IR emitter and IR receiver is disposed above the surgical training model.

19. The system of claim 16, wherein the IR emission array comprises an array of IR diodes having a size which is equal to or greater than a target area of the surgical training model which is to be imaged; and wherein the IR emitter comprises:
a diffuser placed optically downstream from the array of IR diodes;
an anti-scatter grid placed optically downstream from the diffuser that passes IR light that is within a target deviation angle from a desired direction of emission of IR light.

20. The system of claim 19, wherein the anti-scatter grid comprises a grid having pores extending therethrough in a direction which is aligned along a line between the IR emitter and an IR receiver, wherein the pores are separated by walls, and wherein the pores have a cross sectional size and a length such that light passing through the anti-scatter grid is within a target deviation angle from a line between the IR emitter and the IR receiver and such that light from the IR emitter that is emitted at an angle greater than the target deviation angle from the line between the IR emitter and the IR receiver is absorbed by the anti-scatter grid.

21. The system of claim 16, wherein the IR receiver comprises:
a focusing lens; and
an IR bandpass filter.

22. The system of claim 16, wherein the computer system is programmed to process the surgical training model image data by inverting the brightness of the surgical training model image data.

23. The system of claim 22, wherein the computer system is programmed to process the surgical training model image data by at least one of:
applying a histogram equalization to the surgical model image; and
applying a non-linear correction curve to modify the brightness of the surgical training model image.

24. The system of claim 22, wherein the computer system is programmed to process the surgical training model image data by blurring the surgical training model image.
